(19) United States
(12) Patent Application Publication
(10) Pub. No.: US 2023/0200960 A1
(43) Pub. Date: Jun. 29, 2023

(54) DEVICE FOR PREVENTING SUCK-BACK PHENOMENON IN AIR-DRIVEN DENTAL HANDPIECE

(71) Applicant: Yong Weon Kim, San Diego, CA (US)

(72) Inventor: Yong Weon Kim, San Diego, CA (US)

(21) Appl. No.: 18/117,862

(22) Filed: Mar. 6, 2023

Related U.S. Application Data
(63) Continuation-in-part of application No. 17/541,183, filed on Dec. 2, 2021.

(51) Int. Cl. A61C 17/12

(52) U.S. Cl. CPC A61C 17/125

(57) ABSTRACT

A device for preventing suck back of oral secretions into air-driven dental handpiece when the air-driven dental handpiece is stopped. The device includes a high-pressure valve to close a high-pressure inlet port and a low-pressure valve to close a low-pressure inlet port or an exhaust air outlet. The device further includes an actuating member that closes the high-pressure valve. High pressure air of the air-driven dental handpiece can push back the high-pressure valve to open state. The low-pressure valve is coupled to the high-pressure and moves with it. A compression member interrupts the low-pressure valve and the high-pressure valve, wherein the compression member causes the low-pressure valve to close first while allowing the high-pressure valve to keep moving further to close the first path with a time delay.

### CROSS-REFERENCE TO RELATED APPLICATIONS

This application is a continuation-in-part of a U.S. Pat. Appl. No. 17/541,183 filed on Dec. 02, 2021 which is incorporated herein by reference in its entirety.

### FIELD OF INVENTION

The present invention relates to a device for preventing the suck-back phenomenon in the air-driven dental handpiece and related devices.

### BACKGROUND

A suck-back phenomenon found in air-powered dental handpieces and related accessories is a long-standing and unsolved problem. Suck-back occurs due to the inertial force of the turbine when the air-driven turbine rotation whines down upon stopping the driving high-pressure air. Suck-back is known to deliver patients’ oral discharges well past the dental handpiece body. Because of this, the apparatus is required to be sterilized using the processes, such as autoclaving, after each use.

Therefore, this phenomenon is very undesirable and unhygienic for patients’ health providing an opportunity for cross-infection.

Solutions exist in the art that addresses the suck-back phenomenon; however, the known solutions suffer from one or more drawbacks that limit their implementation. For example, a U.S. Pat. 5,782,634 discloses a fast-acting valve to prevent the suck-back phenomenon. A “single valve” is actuated by a high-pressure air source to open and close the low-pressure outlet. However, the single valve presents certain drawbacks, such as suck back cannot be fully prevented.

A need is therefore appreciated for a device that is devoid of the drawbacks of the prior art and can efficiently prevent the suck-back phenomena.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a device with a double valve system for preventing suck back phenomenon in the air-driven dental handpieces.

It is another object of the present invention that the device can be easily installed in a dental apparatus.

It is still another object of the present invention that the device can be retrofitted.

It is a further object of the present invention that other features such as an illumination mechanism and power generation mechanism can also be incorporated.

In one aspect, disclosed is a device for preventing suck back of oral secretions into air-driven dental handpiece when the air-driven dental handpiece is stopped. The device includes a high-pressure valve to close a high-pressure inlet port and a low-pressure valve to close a low-pressure inlet port or an exhaust air outlet. The device further includes an actuating member that closes the high-pressure valve. High pressure air of the air-driven dental handpiece can push back the high-pressure valve to open state. The low-pressure valve is coupled to the high-pressure and moves with it. A compression member interrupts the low-pressure valve and the high-pressure valve, wherein the compression member causes the low-pressure valve to close first while allowing the high-pressure valve to keep moving further to close the first path with a time delay.

In one aspect, disclosed is a device for preventing suck back phenomenon in an air-driven dental handpiece, the air-driven dental handpiece comprises a high-pressure inlet port for high-pressure air intake and a low-pressure inlet port for exhaust air intake, the device comprises: a high-pressure valve configured to be sealably coupled to the high-pressure inlet port; a low-pressure valve configured to be sealably coupled to the low-pressure inlet port; an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path, wherein, the low-pressure valve is coupled to the high-pressure valve or the actuating member through a push rod, wherein the high-pressure valve moves with the low-pressure valve; and a compression member that interrupts the low-pressure valve and the push rod, the compression member is configured to cause the low-pressure valve to close first while allowing the high-pressure valve to keep moving further to close the first path with a time delay, wherein the time delay is a duration between closing of the low-pressure valve and the high-pressure valve. The high-pressure valve is made from low-friction material configured to smoothly slide within a cylindrical housing and the low-pressure valve is made from rubber. The actuating member is a pneumatic cylinder backed by a compression spring. The time delay is proportional to a compressibility of the compression member and/or a length of the push rod. The compression member is a recoiling spring or an elastic material. The compression member is integral with the low-pressure valve and the compression member is coupled the push rod. Alternatively, the compression member interrupts the push rod.

In one aspect, disclosed is dental apparatus comprising an air-driven dental handpiece and a device. The air-driven dental handpiece comprises a high-pressure inlet port for high-pressure air intake and a low-pressure inlet port for exhaust air intake. The device is for preventing suck back phenomenon in the air-driven dental handpiece. The device comprises a high-pressure valve configured to be sealably coupled to the high-pressure inlet port; a low-pressure valve configured to be sealably coupled to the low-pressure inlet port; an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path, wherein, the low-pressure valve is coupled to the high-pressure valve or the actuating member through a push rod, wherein the high-pressure valve moves with the low-pressure valve; and a compression member that interrupts the low-pressure valve and the push rod, the compression member is configured to cause the low-pressure valve to close first while allowing the high-pressure valve to keep moving further to close the first path with a time delay, wherein the time delay is a duration between closing of the low-pressure valve and the high-pressure valve.

In one aspect, disclosed is a device for preventing suck back phenomenon in an air-driven dental handpiece, the air-driven dental handpiece comprises a high-pressure inlet port for high-pressure air intake and an exhaust air outlet for exhaust air outlet, the device comprises: a high-pressure valve configured to be sealably coupled to the high-pressure inlet port; a low-pressure valve configured to be sealably coupled to the exhaust air outlet; an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path, wherein, the low-pressure valve is coupled to the high-pressure valve or the actuating member through a push rod, wherein the high-pressure valve moves with the low-pressure valve; and a compression member that interrupts the low-pressure valve and the push rod, the compression member is configured to cause the low-pressure valve to close first while allowing the high-pressure valve to keep moving further to close the first path with a time delay, wherein the time delay is a duration between closing of the low-pressure valve and the high-pressure valve.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a parallel stroke device, according to an exemplary embodiment of the present invention.

FIG. 2 shows the parallel stroke device in a closed state, according to an exemplary embodiment of the present invention.

FIG. 3 shows the parallel stroke device in an open state, according to an exemplary embodiment of the present invention.

FIG. 4 shows an opposite stroke device, according to an exemplary embodiment of the present invention.

FIG. 5 shows the opposite stroke device in a closed state, according to an exemplary embodiment of the present invention.

FIG. 6 shows the opposite stroke device in an open state, according to an exemplary embodiment of the present invention.

FIG. 7 shows the device installed in a dental apparatus, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Reference numerals:

| | |
|---|---|
| 100: | Parallel stroke device |
| 110: | High-pressure valve |
| 120: | Actuating member |
| 130: | Pushrod |
| 140: | Low-pressure valve |
| 150: | Air-tight seats |
| 160: | Air vent hole |
| 170: | Compression member |
| 200: | Opposite stroke device |
| 210: | High-pressure valve |
| 220: | Actuating member |
| 230: | Pushrod |
| 240: | Low-pressure valve |
| 250: | Air-tight seats |
| 260: | Air vent hole |
| 270: | Compression member |
| 300: | dental apparatus |
| 310: | dental handpiece |
| 320: | swivel coupling |
| 330: | adaptor |
| 350: | hose connector |
| 350: | hose |
| 10: | device |

Disclosed is a device for preventing suck back phenomenon in the air-driven dental handpieces and related devices when the high-pressure air supply is stopped. The disclosed device is implemented as a double-valve system that closes both the low-pressure outlet line and high-pressure inlet line with a time delay at the high-pressure inlet line.

The time delay at the high-pressure inlet valve ensures that the low-pressure outlet valve closes first so that all internal space upstream of the low-pressure outlet valve is pressurized while the high-pressure inlet is still receiving air just before its closing. The time delay is critical for preventing any suck-back that may occur if the high-pressure inlet valve is closed. This way the internal cavities including the dental handpiece head are at a substantially higher pressure than the surroundings so that no suck-back phenomenon occurs.

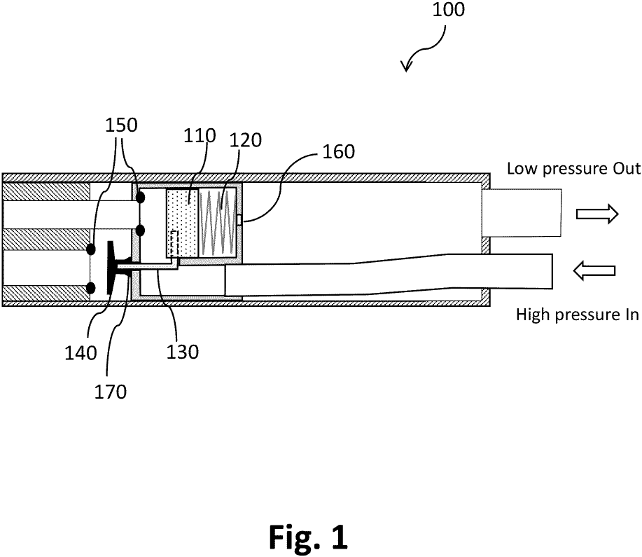

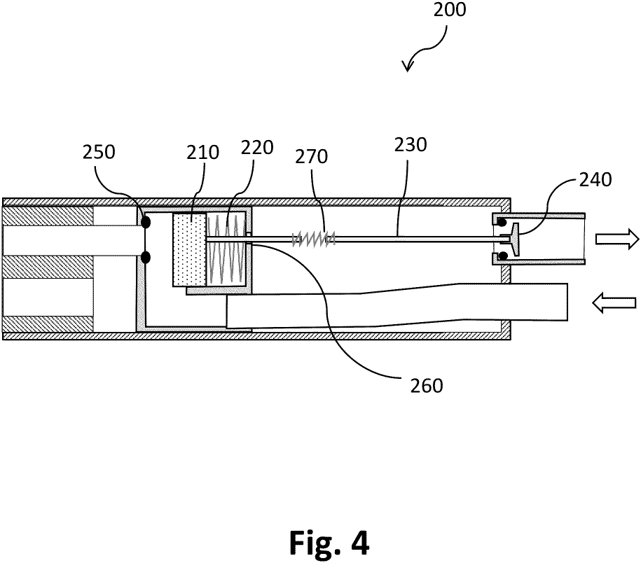

The disclosed device can be implemented in two forms i.e., a parallel stroke mode and an opposite stroke mode. FIG. 1 shows a parallel stroke device 100 and FIG. 4 shows an opposite stroke device 200.

Referring to FIGS. 1-3 which show an exemplary embodiment of the device i.e., the parallel stroke device 100. The parallel stroke device 100 includes a high-pressure valve 110, an actuating member 120, a push rod 130, a low-pressure valve 140, air-tight seals 150, an air vent hole 160, and a compression member 170. The device can include a high-pressure inlet port for high-pressure air intake and a low-pressure inlet port for exhaust air intake into the device. Both the inlets can be provided with airtight seats 150 on which the high-pressure valve 110 and the low-pressure valve 140 can sealably be seated to close the respective path for air.

The high-pressure valve may be constructed with a low-friction material that can smoothly slide within a housing. The high-pressure valve can move inside a cylindrical cavity by the balance of pressure force and force exerted by the actuating member. The low-pressure valve can be constructed with rubber-like material or hard material. The low-pressure valve 140 may be designed to block air escaping from the dental handpiece when closed.

The high-pressure valve 110 can be operably coupled to the actuating member 120 such that the actuating member 120 can push the high-pressure valve 110 against the respective airtight seat for closing the path for high-pressure air. The actuating member 120 can extend to push the high-pressure valve 110 against the seat for creating an airtight seal. The actuating member 120 can be retracted by the force of high-pressure air resulting in the opening of the path. The actuating member 120 can a pneumatic cylinder backed by a compression spring. The drawings show the spring as the actuating member 120, wherein the spring can extend to push the high-pressure valve 110 and can be retracted by the force of the high-pressure air.

The low-pressure valve 140 can be seated on the exhaust air inlet and functions to block air escaping from the dental handpiece when closed. The low-pressure valve 140 can be operably coupled to the high-pressure valve 110 or the actuating member 120 by way of the push rod 130, such that the low-pressure valve 140 moves with the high-pressure valve 110. The closing of the high-pressure valve 110 also closes the low-pressure valve 140 but with a time delay at the high-pressure valve 110. The compression member 170 interrupts the low-pressure valve 140 and the push rod 130. The compression member 170 causes the low-pressure valve 140 to close first while allowing the push rod 130 and thus the high-pressure valve 110 to keep moving further to close the high-pressure inlet port with a time delay. This time delay is proportional to the compressibility of the compression member 170 and air-tight seals 150. In an embodiment, the disclosed device may allow fine-tuning the compressibility and/or the length of the push rod to adjust the time delay. In one implementation the compression member 170 can be a spring or a rubber. The compression member 170 can be built into/integral with the low-pressure valve 140 and can connect to the push rod 130. For example, the low-pressure valve can be made from a compliant material. Alternatively, compression member 170 can interrupt the push rod, and an extension of the push rod can connect compression member 170 to the low-pressure valve 140. The material of the compression member 170 can be varied without departing from the scope of the present invention.

The vent hole 160 may allow the air within the housing of the actuating member 120 to escape, thus preventing the build-up of any pressure or vacuum.

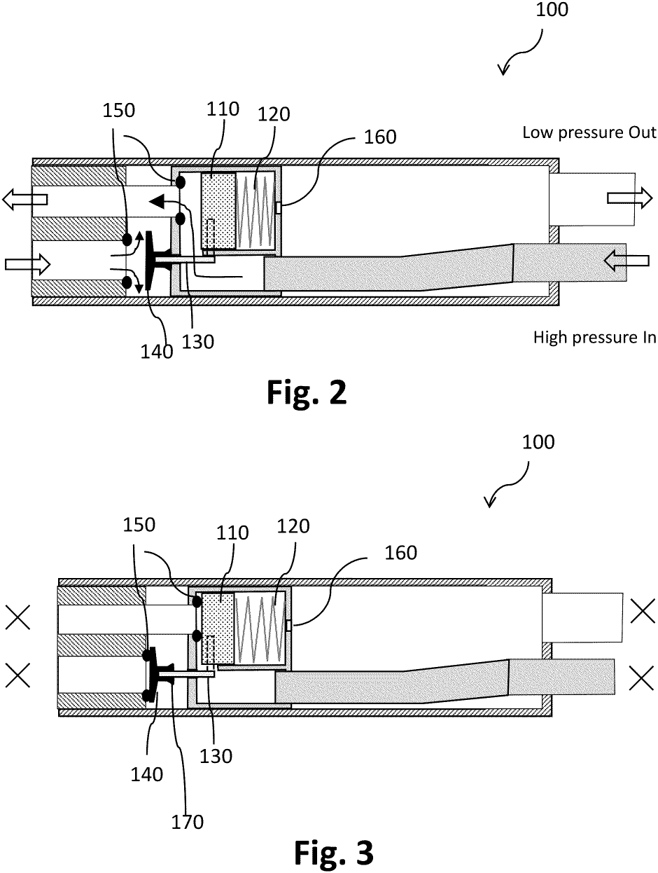

In operation, the two valves of the disclosed device can keep both paths for the high-pressure air and the exhaust air closed, as shown in FIG. 2. When the dental apparatus is started i.e., high-pressure air is supplied, the force of the high-pressure push back the high-pressure valve 110 and thus the actuating member 120 causing the opening of the path. With the opening of the high-pressure valve, the low-pressure valve 140 can also open simultaneously pulled by the push rod. When the dental apparatus is closed, the decrease in pressure of air allows the actuating member 120 to extend closing the low-pressure valve 140 first and then closing the high-pressure valve 110 with the time delay. The time delay is the small-time gap between two valves’ closing events whereby high-pressure air is trapped inside the dental handpiece head and body cavities as the low-pressure valve block air to escape from the handpiece while high-pressure air is still pumped into the dental handpiece for a short duration.

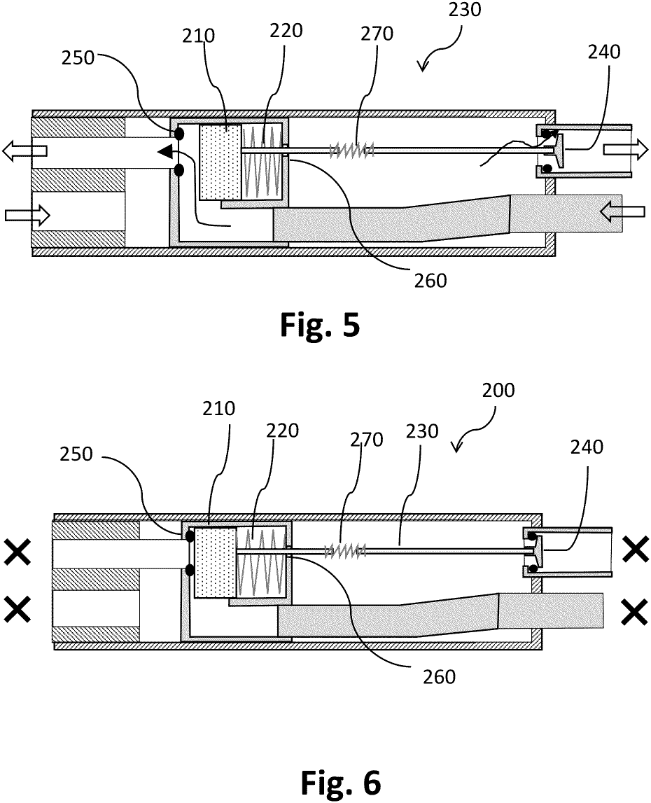

Referring to FIGS. 4-6 show another implementation of the disclosed device in the opposite stroke mode. Most of the features and working of the opposite stroke device 200 are similar to parallel stroke devices hence all the details are not repeated here and only the differences are explained. The opposite stroke device 200 includes the low-pressure valve 240 at a different position i.e., at an exhaust air outlet. Rather than pushing the low-pressure valve 140, the push rod 230 pulls the low-pressure valve 240 to the closing state i.e., against the air-tight seat. The compression member 270 which is shown to be a spring is stretched to cause the time delay. Herein, the time delay is proportional to the stretchability of the compression member 270.

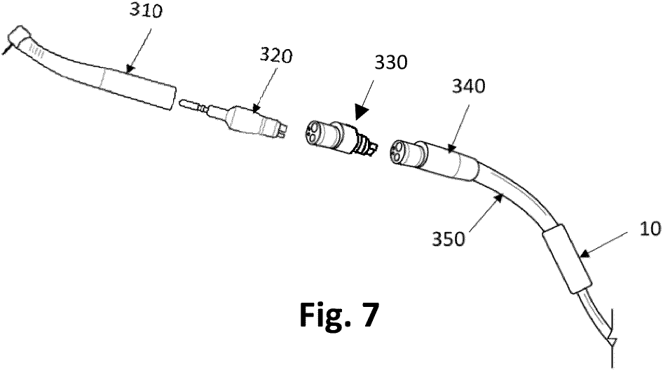

The disclosed device can be easily installed in the dental apparatus without requiring any significant modification. The disclosed device does not hinder the incorporation of other features in the dental apparatus, such as a power generator. The disclosed device can be implemented in any component of the dental apparatus that has a high-pressure air inlet and a low-pressure air outlet. Referring to FIG. 7 shows a dental apparatus 300 where the disclosed device can be implemented in various forms. Dental apparatus 300 shows a dental handpiece 310, swivel coupling, 320, an adaptor 330, hose connector 340, hose 350, and in-line adaptor 10. The disclosed device can be embodied into a dental handpiece 310, swivel couple 320, or hose connector 340. Or it can also be implemented as a stand-alone adaptor device such as adaptor 330 or in-line adaptor 10.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A device for preventing suck back phenomenon in an air-driven dental handpiece, the air-driven dental handpiece comprises a high-pressure inlet port for high-pressure air intake and a low-pressure inlet port for exhaust air intake, the device comprises:
a high-pressure valve configured to be sealably coupled to the high-pressure inlet port;
a low-pressure valve configured to be sealably coupled to the low-pressure inlet port;
an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path,
wherein, the low-pressure valve is coupled to the high-pressure valve or the actuating member through a push rod, wherein the high-pressure valve moves with the low-pressure valve; and
a compression member that interrupts the low-pressure valve and the push rod, the compression member is configured to cause the low-pressure valve to close first while allowing the high-pressure valve to keep moving further to close the first path with a time delay,
wherein the time delay is a duration between closing of the low-pressure valve and the high-pressure valve.

2. The device according to claim 1, wherein the high-pressure valve is made from low-friction material configured to smoothly slide within a cylindrical housing.

3. The device according to claim 1, wherein the low-pressure valve is made from rubber.

4. The device according to claim 1, wherein the actuating member is a pneumatic cylinder.

5. The device according to claim 1, wherein the actuating member is a recoil spring.

6. The device according to claim 1, wherein the time delay is proportional to a compressibility of the compression member.

7. The device according to claim 1, wherein the time delay is proportional to a length of the push rod.

8. The device according to claim 1, wherein the compression member is a spring or an elastic material.

9. The device according to claim 1, wherein the compression member is integral with the low-pressure valve, the compression member is coupled the push rod.

10. The device according to claim 1, wherein the compression member interrupts the push rod.

11. A dental apparatus comprising:
an air-driven dental handpiece, the air-driven dental handpiece comprises a high-pressure inlet port for high-pressure air intake and a low-pressure inlet port for exhaust air intake; and
a device for preventing suck back phenomenon in the air-driven dental handpiece, the device comprises:
a high-pressure valve configured to be sealably coupled to the high-pressure inlet port;
a low-pressure valve configured to be sealably coupled to the low-pressure inlet port;
an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path,
wherein, the low-pressure valve is coupled to the high-pressure valve or the actuating member through a push rod, wherein the high-pressure valve moves with the low-pressure valve; and
a compression member that interrupts the low-pressure valve and the push rod, the compression member is configured to cause the low-pressure valve to close first while allowing the high-pressure valve to keep moving further to close the first path with a time delay,
wherein the time delay is a duration between closing of the low-pressure valve and the high-pressure valve.

12. A device for preventing suck back phenomenon in an air-driven dental handpiece, the air-driven dental handpiece comprises a high-pressure inlet port for high-pressure air intake and an exhaust air outlet for exhaust air outlet, the device comprises:
a high-pressure valve configured to be sealably coupled to the high-pressure inlet port;
a low-pressure valve configured to be sealably coupled to the exhaust air outlet;
an actuating member configured to be operably coupled to the high-pressure valve and configured to push the high-pressure valve against a seat coupled to the high-pressure inlet port closing a first path through the high-pressure inlet port, the actuating member is configured to be retracted by a force of high-pressure air resulting in retraction of the high-pressure valve and opening of the first path,
wherein, the low-pressure valve is coupled to the high-pressure valve or the actuating member through a push rod, wherein the high-pressure valve moves with the low-pressure valve; and
a compression member that interrupts the low-pressure valve and the push rod, the compression member is configured to cause the low-pressure valve to close first while allowing the high-pressure valve to keep moving further to close the first path with a time delay,
wherein the time delay is a duration between closing of the low-pressure valve and the high-pressure valve.

13. The device according to claim 12, wherein the high-pressure valve is made from low-friction material configured to smoothly slide within a cylindrical housing and the low-pressure valve is made from rubber.

14. The device according to claim 12, wherein the actuating member is a pneumatic cylinder.

15. The device according to claim 12, wherein the actuating member is a spring.

16. The device according to claim 12, wherein the time delay is proportional to stretchability of the compression member.

17. The device according to claim 12, wherein the time delay is proportional to a length of the push rod.

18. The device according to claim 12, wherein the compression member is a spring or an elastic material.

19. The device according to claim 12, wherein the compression member is integral with the low-pressure valve, the compression member is coupled the push rod.

20. The device according to claim 12, wherein the compression member interrupts the push rod.
